(19) United States
(12) Patent Application Publication
(10) Pub. No.: US 2015/0310591 A1
(43) Pub. Date: Oct. 29, 2015

(54) IMAGE SIGNAL PROCESSING DEVICE

(71) Applicant: SHARP KABUSHIKI KAISHA, Osaka-shi, Osaka (JP)

(72) Inventor: Masayuki TAKAHASHI, Osaka-shi (JP)

(21) Appl. No.: 14/441,616

(22) PCT Filed: Nov. 27, 2013
(86) PCT No.: PCT/JP2013/081906

§ 371 Date: May 8, 2015

(30) Foreign Application Priority Data
Dec. 5, 2012 (JP) 2012-266762

(51) Int. Cl. G06T 3/40; H04N 7/015; H04N 21/43; G09G 5/377; H04N 5/04

(52) U.S. Cl. CPC G06T 3/4038; G09G 5/377; H04N 5/04; H04N 21/4307; G06T 3/4053; H04N 7/0152

(57) ABSTRACT

Even in a case in which an image signal that is not normal is included, a display based on a normal image signal is performed. Input signal determination circuits (11A, 11B) replace an abnormal image signal which is determined not to be able to be synchronized by a synchronization circuit (12), among image signals which are included in either a first image signal group or a second image signal group, with an image signal which can be synchronized by the synchronization circuit (12), according to another image signal which is included in either the first image signal group or the second image signal group.

### TECHNICAL FIELD

The present invention relates to an image signal processing device and an image display apparatus.

### BACKGROUND ART

In recent years, an image display apparatus which displays an image with a resolution (for example, equal to or higher than 4 k2 k) higher than Full HD has been proposed.

In PTL 1, an image processing technology for such an image display apparatus which displays an image with a high resolution is described in which image data (image signal) corresponding to a displayed image is divided into multiple pieces and processed is described.

FIG. 11 is a diagram illustrating an input method and a processing method of partial image data Din1 to 4 according to the change of an input mode, in the image processing device of PTL 1.

As illustrated in FIG. 11, in an image display apparatus which displays an image with a high resolution, a display area is divided into multiple pieces, a plurality of divided image signals are input to respective divided display areas (division display areas), and thereby an image with a high resolution is displayed.

### CITATION LIST

### Patent Literature

PTL 1: Japanese Unexamined Patent Application Publication No. 2011-180336 (Published on Sep. 15, 2011)

### SUMMARY OF INVENTION

### Technical Problem

However, in a case in which a plurality of image signals which are obtained by dividing an image with a high resolution into multiple pieces are input to the respective division display areas, and an image with a high resolution is displayed, it is necessary for the image signals which are input to the respective division display areas to be synchronized with each other.

For example, in an image display apparatus for Super High Vision (SHV), a display area is divided into sixteen pieces, an image signal is divided into sixteen pieces, and the sixteen image signals are input to the respective division display areas in parallel.

If there is an image signal which is not input normally, among the sixteen image signals, the image signals are not appropriately synchronized with each other, and in the same manner as in display areas illustrated in FIG. 12, abnormality occurs, such as a screen being disturbed (FIG. 12(a)), or an image not being displayed on the whole screen (FIG. 12(b)).

This is because sixteen image signals are respectively independent and include signals for the synchronization with each other, and thus if at least one of those is not input normally, nothing is displayed on the division display area on which an image corresponding to the image signal which is not input normally is displayed, and a condition for synchronization is not satisfied.

In an image display apparatus with a plurality of displays, each of the displays independently displays an image, and thus even in a case in which an image signal is not transmitted normally, only one display does not display any image, and thus a particular problem does not occur. However, in a case in which one liquid crystal panel performs a display, it is necessary to synchronize a plurality of image signals to perform a display, and thus if even a single image signal is not transmitted normally, it is not possible to synchronize the image signals and to display an image.

As described above, in an image display apparatus which displays an image with a high resolution by assigning image signals obtained by dividing the image with a high resolution into multiple pieces, on the respective division display areas, in a case in which at least one of the image signals which are input to the respective division display areas is not input normally, abnormality occurs, such as a screen being disturbed, or an image not being displayed.

The present invention is to solve the above-described problems, and an object of the present invention is to provide an image signal processing device and an image display apparatus for performing a display based on a normal image signal even in a case in which an image signal that is not normal is included in image signals, in an image display apparatus which displays an image with a high resolution by assigning image signals for division display of an image with a high resolution, for respective division display areas which are obtained by dividing a display area into multiple pieces.

### Solution to Problem

In order to solve the above-described problems, according to an aspect of the invention, there is provided an image signal processing device, which outputs in parallel image signals that are assigned to respective division display areas obtained by dividing a display area of a display device into multiple pieces and that are synchronized with each other, including a synchronization unit which synchronizes the image signals that are assigned to the respective division display areas; and an image signal determination unit which determines whether or not an image signal which is input to the synchronization unit is an image signal that can be synchronized by the synchronization unit, in which the image signal determination unit receives a first image signal group which includes a set of image signals that is assigned to the respective division display areas, and a second image signal group which includes another set of image signals that is assigned to the respective division display areas, and in which the image signal determination unit replaces an abnormal image signal which is determined not to be able to be synchronized by the synchronization unit, among the image signals which are included in either the first image signal group or the second image signal group, with an image signal which can be synchronized by the synchronization unit, according to the image signals which are included in either the first image signal group or the second image signal group.

### Advantageous Effects of Invention

According to the aspect of the present invention, it is possible to provide an image signal processing device for performing a display based on a normal image signal even in a case in which an image signal that is not normal is included in image signals that are input from the outside, in an image display apparatus which displays an image with a high resolution by inputting image signals for division display of an image with a high resolution, for respective division display areas which are obtained by dividing a display area into multiple pieces.

### BRIEF DESCRIPTION OF DRAWINGS

FIG. 1 is a block diagram illustrating a configuration of an image display apparatus according to Embodiment 1 of the present invention.

FIG. 2 is a diagram illustrating a relationship between a division display area and an image signal of the image display apparatus according to the Embodiment 1.

FIG. 3 is a diagram illustrating replacement processing of an image signal of an input signal determination circuit according to Embodiment 1.

FIG. 4 is a diagram illustrating another replacement processing of the image signal of the input signal determination circuit according to Embodiment 1.

FIG. 5 is a diagram illustrating an appearance of a display area of the image display apparatus according to Embodiment 1, in a case in which all the image signals which are input to the input signal determination circuit are abnormal image signals.

FIG. 6 is a diagram illustrating an appearance of the display area of the image display apparatus according to Embodiment 1, in a case in which the whole image display is performed with one normal image signal.

FIG. 7 is a diagram illustrating an appearance of a display area in a case in which replacement processing of an image signal of an input signal determination circuit according to Embodiment 2 is performed.

FIG. 8 is a diagram illustrating an appearance of the display area in a case in which another replacement processing of the image signal of the input signal determination circuit according to Embodiment 2 is performed.

FIG. 9 is a block diagram illustrating a configuration of an image display apparatus according to Embodiment 3 of the present invention.

FIG. 10 is a diagram illustrating an appearance of a display area in a case in which replacement processing of an image signal of an input signal determination circuit according to Embodiment 3 is performed.

FIG. 11 is a diagram illustrating an input method and a processing method of partial image data Din1 to 4 according to the change of an input mode of the image processing device of PTL 1 of the related art.

FIG. 12 is a diagram illustrating an appearance of a display area in a case in which image signals are not synchronized.

### DESCRIPTION OF EMBODIMENTS

### Embodiment 1

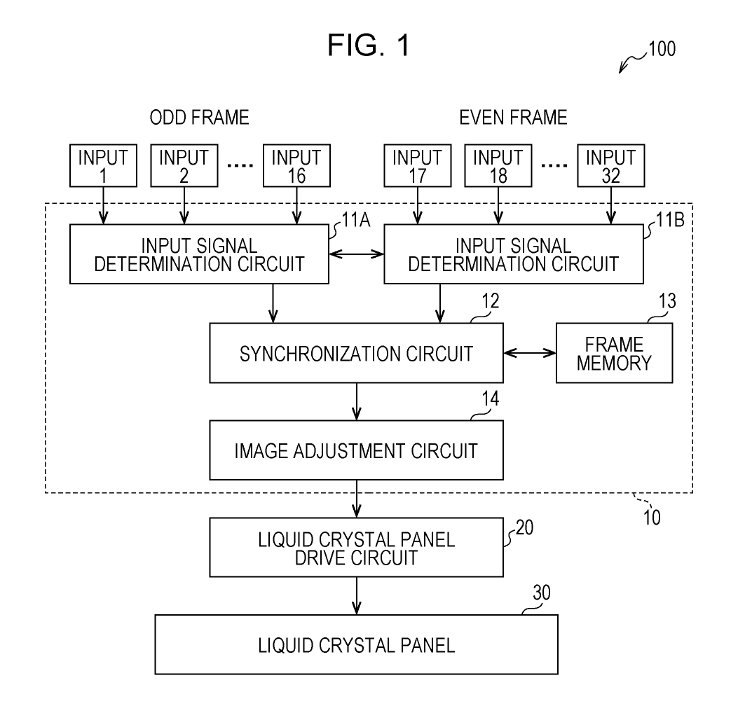

Hereinafter, embodiments of the present invention will be described in detail with reference to FIGS. 1 to 6.

In the following description, an image display apparatus which displays a super high vision image with a resolution of 8 k4 k (7680×4320 dots) will be described as an image display apparatus of the present invention.

Since an image with a resolution higher than Full HD (1920×1080 dots) is not standardized for a broadcast wave or an image medium at present, it is not possible to transfer the image signal with a high resolution as it is and to input the image signal to an image display apparatus.

Thus, a method is considered in which by dividing an image into multiple pieces, the resolutions of the divided images are decreased to approximately Full HD, the divided images are transferred by a broadcast wave or an image medium, and are input to an image display apparatus.

In the present embodiment, a case in which the original image with a resolution of 7680×4320 dots is divided into sixteen images with a resolution of 1920×1080 dots will be described.

### (Display Device)

FIG. 1 is a block diagram of an image display apparatus according to an embodiment of the present invention.

As illustrated in FIG. 1, an image display apparatus 100 according to the present embodiment includes an image signal processing device 10, a liquid crystal panel drive circuit 20, and a liquid crystal panel 30.

The liquid crystal panel 30 has a resolution of 8 k4 k (7680×4320 dots). A single display area is divided into sixteen pieces, in such a manner that sixteen images with 1920×1080 dots can be displayed, and each of the divided display areas (division display area) is independently driven.

The liquid crystal panel 30 can sequentially update the images which are displayed on the display area, and it is assumed that a frame frequency is 120 Hz. That is, the liquid crystal panel 30 rewrites the images 120 times in one second.

The liquid crystal panel drive circuit 20 independently drives the sixteen division display areas in the liquid crystal panel 30. Specifically, since an image signal from the image signal processing device 10 is supplied to a corresponding division display area of the liquid crystal panel 30, images corresponding to respective division display areas are displayed.

The image signal processing device 10 outputs in parallel a plurality of image signals which are input from the outside to the liquid crystal panel drive circuit 20 as image signals which are synchronized with each other.

As described, a frame frequency of the liquid crystal panel 30 is 120 Hz. In accordance with the frame frequency, the image signal determination device 10 according to the present embodiment simultaneously receives the image signals of two frames (amount of two images) from the outside. The image signals of two frames are configured by, for example, image signals for odd frame display and image signals for even frame display.

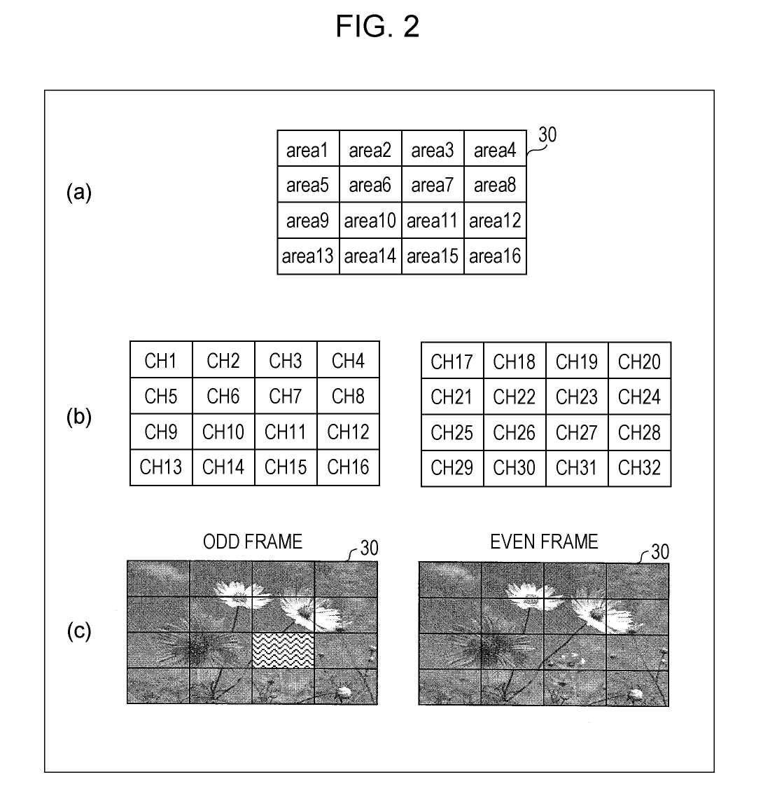

FIG. 2 is a diagram illustrating a relationship between a division display area and an image signal of the liquid crystal panel.

In the liquid crystal panel 30, the display area is divided into sixteen pieces as illustrated in FIG. 2(a), and each of the divided display areas area1 to area16 are independently driven. For example, as illustrated in FIG. 2(b) and FIG. 2(c), for an odd frame, based on the image signals of CH1 to CH16 which are an image signal group (first image signal group) for odd frame display, an image is displayed in each division display area, and for an even frame, based on the image signals of CH17 to CH32 which are an image signal group (second image signal group) for even frame display, an image is displayed in each division display area.

As a result, the images of odd frames and the images of even frames are alternately displayed, and thus it is possible to sequentially update the images.

In the image display apparatus of the related art, in a case in which the image signals of two frames are simultaneously input, and image signals are synchronized with each other and are output to the liquid crystal panel drive circuit, if the image signals for one frame are input normally, and the image signals of the other frame are not input normally, the synchronization of the image signals of both frames is disturbed, and thus normal images are not displayed.

In contrast to this, the image display apparatus 100 according to the present embodiment includes the image signal processing device 10, and thus, even if an abnormal signal is included in the image signals of two frames, it is possible to perform a normal display, based on the other normal image signals.

Hereinafter, specific description will be made.

### (Image Signal Processing Device)

As illustrated in FIG. 1, the image signal processing device 10 includes an input signal determination circuit 11A (image signal determination unit), an input signal determination circuit 11B (image signal determination unit), a synchronization circuit 12 (synchronization unit), a frame memory 13, and an image adjustment circuit 14.

32 image signals (input1 to input32) are simultaneously input to the image signal processing device 10. More specifically, sixteen image signals (input1 to input16) are input to the input signal determination circuit 11A, and sixteen image signals (input17 to input32) are input to the input signal determination circuit 11B.

The sixteen image signals which are input to the input signal determination circuit 11A respectively correspond to the image signals of one frame of the images which are displayed on the sixteen division display areas of the liquid crystal display panel. In addition, the sixteen image signals which are input to the input signal determination circuit 11B also respectively correspond to the image signals of one frame of the images which are displayed on the sixteen division display areas of the liquid crystal display panel.

For example, the image signals which are input to the input signal determination circuit 11A can be set as the image signals corresponding to an odd frame of an image which is displayed on division display areas, and the image signals which are input to the input signal determination circuit 11B can be set as the image signals corresponding to an even frame of an image which is displayed on division display areas.

As illustrated in FIG. 2, for odd frames, based on the image signals which are input to the input signal determination circuit 11A, the display is performed in each division display area. Meanwhile, for even frames, based on the image signals which are input to the input signal determination circuit 11B, the display is performed in each division display area.

The input signal determination circuits 11A and 11B determine whether or not the image signals which are input are normally transmitted signals, and any of the 32 image signals are distributed according to the determination results and are transferred to the synchronization circuit. That is, the input signal determination circuits 11A and 11B determine whether or not the image signals (input1 to input32) satisfy a display standard for performing an image display on the division display areas corresponding to each image signal. More specifically, the input signal determination circuits 11A and 11B determine whether or not the image signals are image signals which can be synchronized by a synchronization circuit 12 which will be described later.

Here, the display standard for performing the image display in a division display area indicates a format of a clock frequency which is defined for the image signal. That is, the input signal determination circuits 11A and 11B determine whether or not the format of the image signal is a format which is defined in advance.

Since the image signal is input with the format which is defined in advance, the input signal determination circuits 11A and 11B determine whether the image signal is an image signal (normal image signal) which can be synchronized by the synchronization circuit 12, or is an image signal (abnormal image signal) which is not transmitted normally and which cannot be synchronized by the synchronization circuit 12 by using a clock frequency and the frequency of the synchronization signal.

The input signal determination circuits 11A and 11B replace the abnormal image signal which is determined to be a signal which cannot be synchronized by the synchronization circuit 12, by allocating another image signal. As an allocation method in this case, for example, there is a method in which selectors are disposed in input units of the input signal determination circuits 11A and 11B, and input signals are selectively input by the selectors, or there is a method in which signal wires are switched by various units such as a buffer unit and an output unit, and either one of the methods may be employed.

The synchronization circuit 12 synchronizes 32 image signals from the input signal determination circuits 11A and 11B, retains the image signals in the frame memory 13 as necessary, and outputs the image signals to the image adjustment circuit 14 in the subsequent stage.

The image adjustment circuit 14 performs an adjustment of color, gamma, brightness, contrast, or the like of an image, with respect to each image signal from the synchronization circuit 12.

In the image display apparatus of the related art, even if an image signal is not input by one of a plurality of cables or the image format of an image signal is different from others, a synchronization module cannot synchronize the whole image, and the screen is disturbed or display cannot be performed.

However, in the image display apparatus 100 with the configuration described above, the input signal determination circuits 11A and 11B distribute images of another area to the division display areas to which the abnormal image signals are supposed to be assigned, and thereby the image signals which are input to the liquid crystal panel drive circuit 20 can be synchronized with each other.

For this reason, even if an abnormal image signal is included in the image signals which are input to the image signal processing device 10, display can be performed without display disturbance occurring on the whole screen, based on the other normal image signals.

### (Replacement Processing of Image Signal)

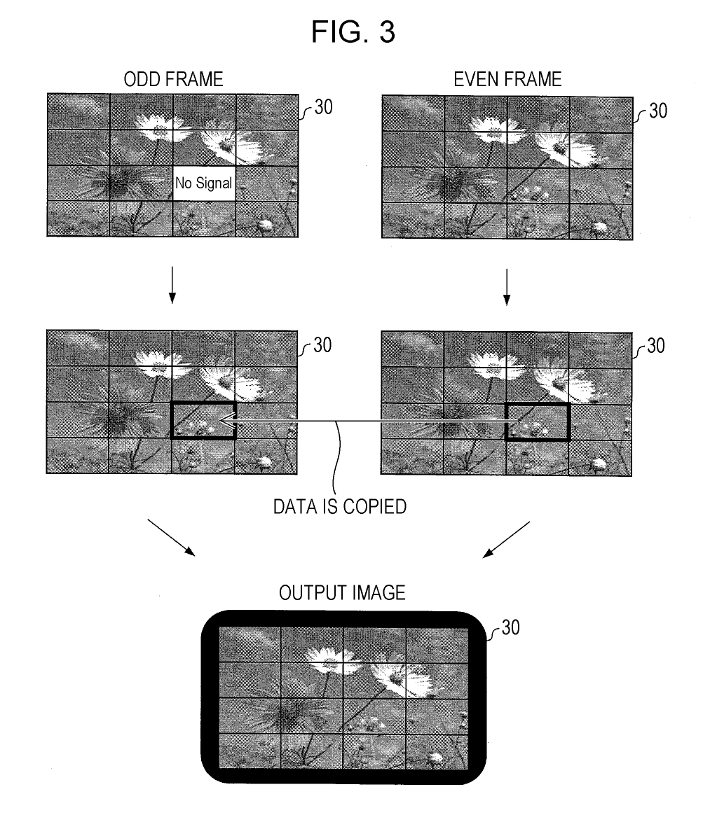

FIG. 3 is a diagram illustrating replacement processing of an image signal of the input signal determination circuit according to the present embodiment.

In a case in which an abnormal image signal is detected from among the input image signals (input1 to input32), the input signal determination circuits 11A and 11B replace the abnormal image signal with a normal image signal, based on the other image signals (input1 to input32).

In a case in which an abnormal image signal is detected from among the input image signals (input1 to input16), the input signal determination circuit 11A according to the present embodiment replaces the abnormal image signal with an image signal which is assigned to a division display area corresponding to the abnormal image signal among the image signals (input17 to input32) which are input to the input signal determination circuit 11B.

In addition, in a case in which an abnormal image signal is detected from among the input image signals (input17 to input32), the input signal determination circuit 11B according to the present embodiment replaces the abnormal image signal with an image signal which is assigned to a division display area corresponding to the abnormal image signal among the image signals (input1 to input16) which are input to the input signal determination circuit 11A.

As a result, when referring to FIG. 2 and FIG. 3, for example, in a case in which an image signal which is input to the input signal determination circuit 11A and corresponds to CH11 is an abnormal image signal, the abnormal image signal is replaced with another image signal. Specifically, the abnormal image signal is replaced with an image signal of CH27 which is assigned to the division display area area11 which corresponds to the abnormal image signal. In other words, the image signal (data) of CH27 is copied, and the copied image signal is output as the image signal of CH11. As a result, in the division display area area11 corresponding to the abnormal image signal, the same image is displayed for an odd frame and an even frame.

As described above, the abnormal image signal is replaced with another normal image signal, and thus the image signal can be synchronized with the others, display disturbance of the whole screen can be prevented, and a substantially normal image can be displayed. Here, the image of an odd frame and the image of an even frame which are displayed on the one division display area approximate to each other in many cases. For this reason, as described above, by replacing an abnormal image signal with a normal image signal, it is possible to display an image close to an image to be originally displayed, in which the abnormal image signal is not included.

In addition, as illustrated in FIG. 4, in a case in which abnormal image signals are detected in both image signals which are input to the input signal determination circuits 11A and 11B, in correspondence to the same division display area, replacement processing is performed as follows.

That is, in a case in which an image signal corresponding to CH11 is an abnormal image signal among the image signals which are input to the input signal determination circuit 11A, and an image signal corresponding to CH27 is an abnormal image signal among the image signals which are input to the input signal determination circuit 11B, the abnormal image signals are replaced with image signals which are assigned to division display areas adjacent to the division display areas corresponding to the abnormal image signals.

Specifically, the abnormal image signal corresponding to CH11 is replaced with an image signal of CH10 which is assigned to a division display area area10 adjacent to a division display area area11 corresponding to the abnormal image signal. In addition, the abnormal image signal corresponding to CH27 is replaced with an image signal of CH26 which is assigned to the division display area area10 adjacent to the division display area area11 corresponding to the abnormal image signal.

As a result, it is possible to prevent the display disturbance of all the display areas, and to easily determine the input of an image signal in which abnormality occurs.

In the example described above, a case in which an abnormal image signal is replaced with an image signal which is assigned to a division display area adjacent to the left of a division display area corresponding to the abnormal image signal is described, but the abnormal signal may be replaced with an image signal assigned to a division display area adjacent to the right, may be replaced with an image signal assigned to a division display area adjacent on the side above, or may be replaced with an image signal assigned to a division display area adjacent on the side below. Furthermore, for a division display area corresponding to the abnormal image signal, priority may be set in advance to other division display areas, and the abnormal image signal may be replaced with an image signal which is assigned to a division display area with a high priority.

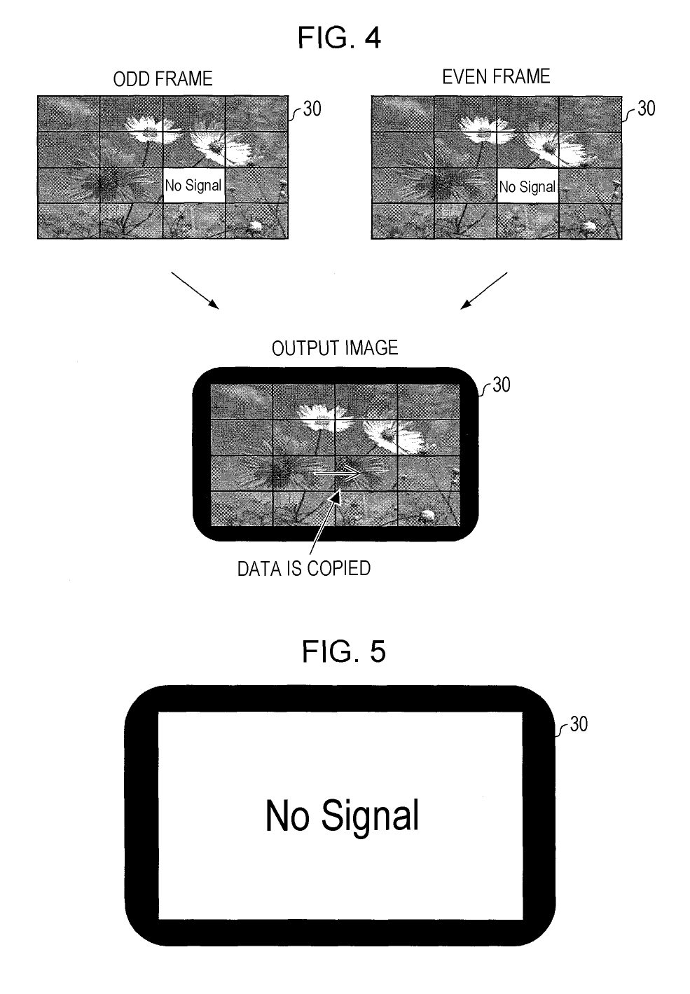

Furthermore, in a case in which all of the image signals which are input to the input signal determination circuits 11A and 11B are abnormal image signals, the input signal determination circuits 11A and 11B output an image signal for displaying characters of “No Signal” on the display area to the synchronization circuit, for example, as illustrated in FIG. 5.

The input signal determination circuits 11A and 11B according to the present embodiment replace abnormal image signals with normal image signals based on other image signals, and output the image signals to the synchronization circuit 12 in the subsequent stage, as described above.

For this reason, since the image signals which are input to the synchronization circuit 12 are normal image signals which do not include an abnormal image signal, the synchronization circuit 12 can synchronize all the image signals.

As described above, according to the image display apparatus 100 of the present embodiment, if at least one of the plurality of image signals which are input from outside is a normal signal, the image signals which are input to the liquid crystal panel drive circuit 20 can be synchronized, and display can be performed on the whole screen of the display areas of the liquid crystal panel 30.

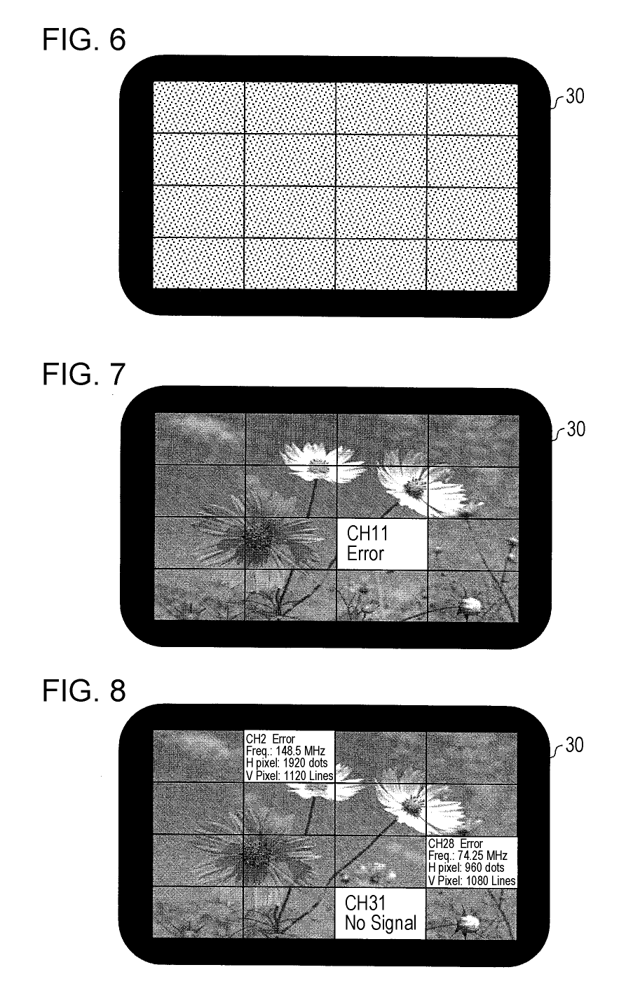

For this reason, if at least one normal image signal is input, as illustrated in FIG. 6, the whole screen display can be performed, display quality can be checked using an image signal with a low resolution, and image adjustment can be performed. As a result, it is possible to reduce a cost required for inspection or adjustment.

### Embodiment 2

Referring to FIG. 7 and FIG. 8, description with regard to another embodiment of the present invention will be made. For convenience, the same symbols or reference numerals will be attached to the members having the same function as that of the members which are described in the above embodiment, and description thereof will be omitted.

In an image display apparatus according to the present embodiment, the input signal determination circuits 11A and 11B do not replace abnormal image signals with another image signals, and replace the abnormal image signals with image signals for displaying an analysis result of the abnormal image signal. As a result, the analysis result is displayed on the division display area for the liquid crystal panel 30 to which the abnormal image signal is originally assigned.

The input signal determination circuits 11A and 11B make the image signals which are transmitted normally pass through, and if there is an image signal (abnormal image signal) which is not normally transmitted, output an image signal for displaying an analysis result of the abnormal image signal to the synchronization circuit 12.

That is, if the divided image signals (input1 to input16) are input, the input signal determination circuits 11A and 11B determine whether or not each image signal is normal, outputs normal image signals to the synchronization circuit 12 in the subsequent stage as they are, analyze the abnormal image signals, and output image signals for displaying the analysis result to the synchronization circuit 12.

The analysis result of the abnormal signal represents, for example, CH to which the abnormal image signal corresponds, a clock frequency, a horizontal resolution, a vertical resolution, or the like. In addition, in a case in which an image signal which is not normal cannot be analyzed, “No Signal” is displayed.

For example, in a case in which the image signal of CH11 is an abnormal image signal, the input signal determination circuits 11A and 11B replace the abnormal image signal with an image signal for displaying that the image signal of CH11 is an abnormal image signal. As a result, as illustrated in FIG. 7, an image which indicates that the image signal of CH11 is an abnormal image signal is displayed on the division display area area11.

In addition, the clock of an image signal and the frequency of a synchronization signal may be analyzed, and analysis result thereof may be displayed. Specifically, as illustrated in FIG. 8, the frequency of a vertical synchronization signal (Vsync) corresponding to a frame rate, the frequency of a horizontal synchronization signal (Hsync) and the number during one vertical period, the number of pieces of data during one horizontal period, the number of lines during one vertical period, or the like are analyzed and displayed. Furthermore, if necessary, lengths of Vsync and Hsync, lengths of front porch and back porch, or the like are also displayed.

Abnormality can occur during transmission by connection mistake of a signal cable, disconnection of a signal cable, connection failure, setting mistake of a signal source, or the like. In this case, it is easy to determine which kind of abnormality occurs in which CH, by displaying states of the image signals which are input.

### Embodiment 3

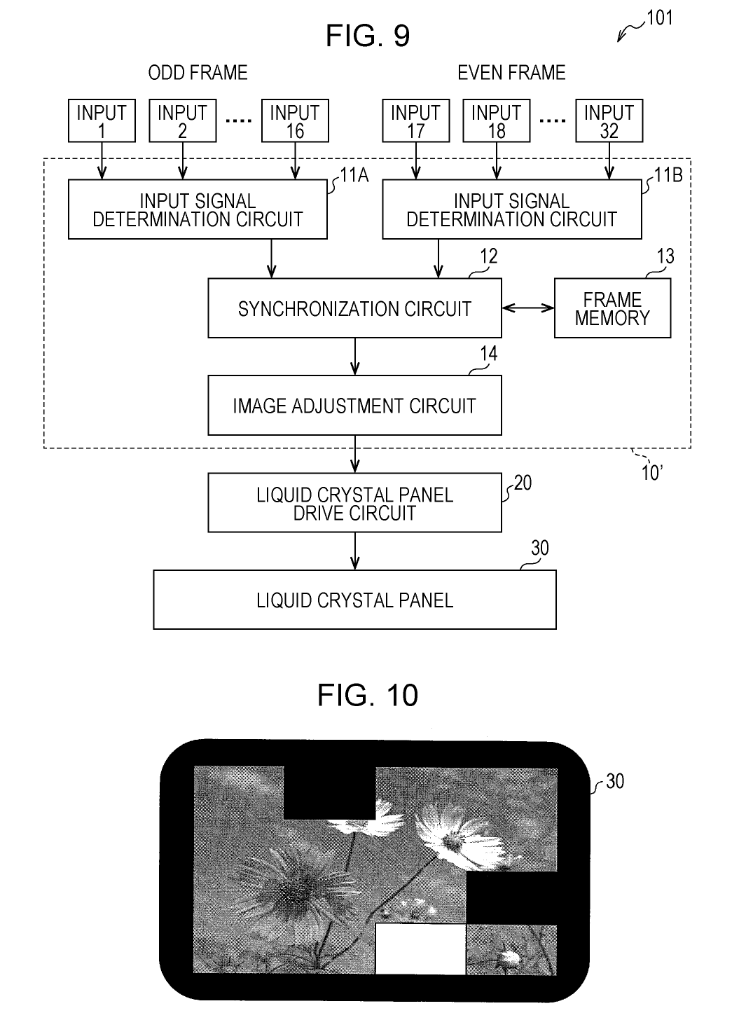

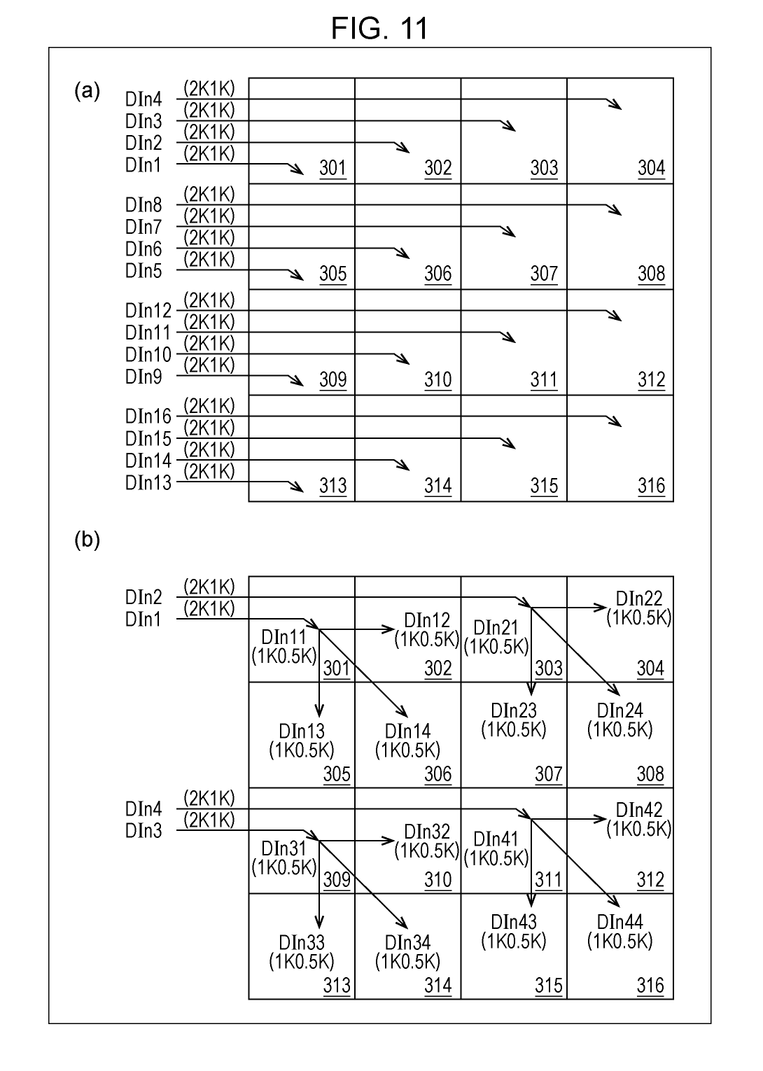

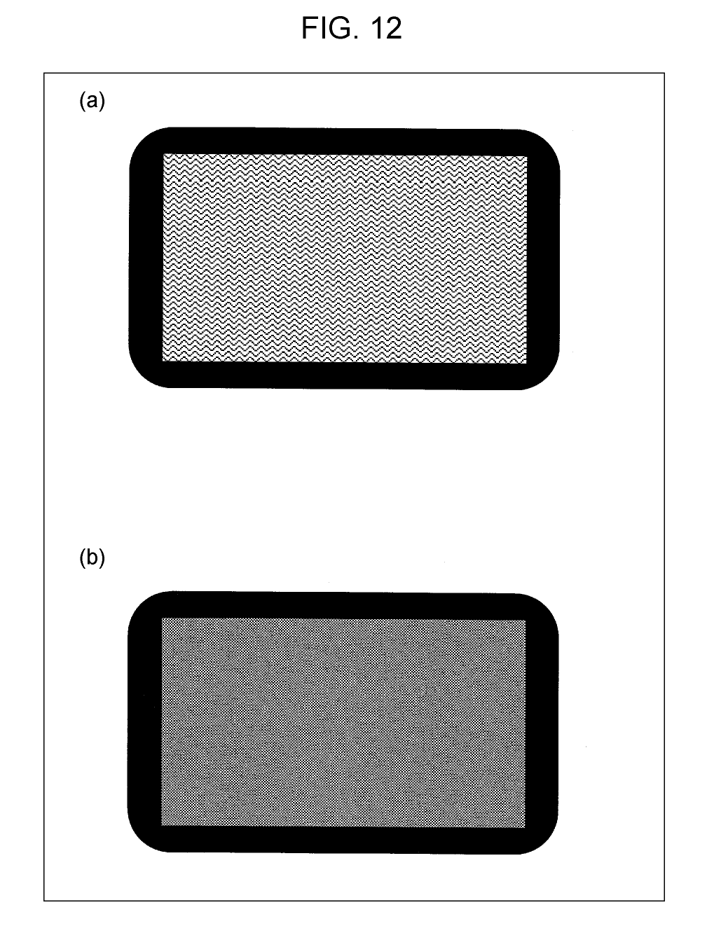

Referring to FIG. 9 and FIG. 10, description with regard to another embodiment of the present invention will be made. For convenience, the same symbols or reference numerals will be attached to the members having the same function as that of the members which are described in the above embodiment, and description thereof will be omitted.

FIG. 9 is a schematic configuration block diagram of an image display apparatus 101 according to the present embodiment.

As illustrated in FIG. 9, the image display apparatus 101 includes an image signal processing device 10′, the liquid crystal panel drive circuit 20, and the liquid crystal panel 30. Here, the image display apparatus 101 has approximately the same configuration as that of the image display apparatus 100 according to Embodiment 1, but the functions of the input signal determination circuit 11A and the input signal determination circuit 11B which are included in the image signal processing device 10′ are slightly different from those in the image signal processing device 10.

That is, in the present embodiment, the input signal determination circuits 11A and 11B replace an image signal (abnormal image signal) which is determined not to be able to be displayed on a division display area with a color signal for displaying the whole division display area using the same color, and output the signal to the synchronization circuit 12 in the subsequent stage.

As the color signal, two colors different from each other can be used, and for example, black and white can be used. That is, the division display area is entirely displayed in black or white.

At this time, in a case in which one of the image signals (input1 to input16) which are input to the input signal determination circuit 11A is an abnormal image signal, the whole surface of the division display area corresponding to the abnormal image signal is displayed in black. In addition, in a case in which one of the image signals (input17 to input32) which are input to the input signal determination circuit 11B is an abnormal image signal, the whole surface of the division display area corresponding to the abnormal image signal is displayed in white.

As a result, as illustrated in FIG. 10, the division display area to which an image signal that is not normal is assigned originally is entirely displayed in black or white, and the abnormality occurrence in the image signal which is input to the division display area becomes obvious.

Furthermore, if there is a division display area which is entirely displayed in black, it can be seen that an image signal which is input to the input signal determination circuit 11A is an abnormal image signal, among the image signals which are assigned to the division display area. If there is a division display area which is entirely displayed in white, it can be seen that an image signal which is input to the input signal determination circuit 11B is an abnormal image signal, among the image signals which are assigned to the division display area. In addition, it is also easy to generate a replacement image signal to be displayed on the division display area.

As the above color signal, a signal with other colors may be used.

In addition, in each embodiment described above, it is assumed that the image display apparatus displays a super high vision image with a resolution of 8 k4 k (7680×4320 dots), and an example in which 32 image signals of Full HD (1920×1080 dots) are used is described, but the present invention is not limited to such an example. For example, an image of 4 k2 k (3840×2160 dots) and four image signals of Full HD (1920×1080 dots) may be used, and other combination may be used.

In each embodiment described above, examples in which the image processing device 10 is mounted in the image display apparatuses 100 and 101 are used, and while not being limited to this, the image processing device 10 may be applied to an apparatus (electronic apparatus) such as a Blu-ray recorder which outputs an image signal and does not include an image display apparatus.

### CONCLUSION

An image signal processing device according to an aspect of the present invention, which outputs in parallel image signals that are assigned to respective division display areas obtained by dividing a display area of a display device into multiple pieces and that are synchronized with each other, includes a synchronization unit which synchronizes the image signals that are assigned to the respective division display areas; and an image signal determination unit which determines whether or not an image signal which is input to the synchronization unit is an image signal that can be synchronized by the synchronization unit, in which the image signal determination unit receives a first image signal group which includes a set of image signals that is assigned to the respective division display areas, and a second image signal group which includes another set of image signals that is assigned to the respective division display areas, and in which the image signal determination unit replaces an abnormal image signal which is determined not to be able to be synchronized by the synchronization unit, among the image signals which are included in either the first image signal group or the second image signal group, with an image signal which can be synchronized by the synchronization unit, according to the image signals which are included in either the first image signal group or the second image signal group.

According to the above-described configuration, the image signal determination unit replaces an abnormal image signal which is determined not to be able to be synchronized by the synchronization unit with an image signal which can be synchronized by the synchronization unit. For this reason, the synchronization unit can synchronize all the image signals, and the image signals which are synchronized with each other are assigned to each division display area.

As a result, even in a case in which an image signal which is not normal is included in the image signals that are input from the outside of the display device, it is possible to perform a display without display disturbance or the like, based on a normal image signal.

The image signal determination unit may replace the abnormal image signal which is included in either the first image signal group or the second image signal group, with an image signal which is included in either the first image signal group or the second image signal group.

According to the above-described configuration, the abnormal image signal can be replaced with another image signal. For this reason, based on another image signal, it is possible to perform a display based on the normal image signal.

The image signal determination unit may replace the abnormal image signal which is included in one group of the first image signal group and the second image signal group, with an image signal which is assigned to the division display area corresponding to the abnormal image signal, among the image signals which are included in the other group of the first image signal group and the second image signal group.

According to above-described configuration, it is possible to replace the abnormal image signal with an image signal which is assigned to the division display area corresponding to the abnormal image signal. In general, there are many cases in which the images which are displayed on the same division display area are similar to each other.

For this reason, as described above, by replacing the abnormal image signal, it is possible to display an image similar to an image which is displayed in a case in which the abnormal image signal is not included, on the display area.

The image signal determination unit may replace the abnormal image signal which is included in either the first image signal group or the second image signal group, with an image signal which is set in advance and has a high priority, among the image signals.

According to the above-described configuration, in each of the first image signal group and the second image signal group, even if image signals which are assigned to the same division display area are abnormal image signals, it is possible to perform a display based on a normal image signal, based on other image signals.

The image signal determination unit may replace the abnormal image signal with an image signal for displaying an analysis result of the abnormal image signal on the division display area.

The image signal for displaying an analysis result of the abnormal image signal may be at least one which is selected from a group consisting of a clock frequency, a horizontal resolution, and a vertical resolution of the abnormal image signal.

According to the above-described configuration, it is possible to display a state of the abnormal image signal.

The image signal determination unit may replace the abnormal image signal with an image signal for displaying the whole surface of the division display area corresponding to the abnormal image signal, in one color.

According to the above-described configuration, it is possible to easily determine the abnormal image signal.

The image signal determination unit may replace the abnormal image signal with an image signal for displaying the whole surface in a color according to an image signal group to which the abnormal image signal belongs.

That is, the image signal determination unit may replace the abnormal image signal with an image signal for displaying the whole surface of the division display area corresponding to the abnormal image signal, in a color according to the image signal group to which the abnormal image signal belongs.

According to the above-described configuration, it is possible to easily determine the abnormal image signal.

An image display apparatus according to an aspect of the present invention may include the image signal processing device.

The present invention is not limited to each embodiment described above, various modifications can be made within the scope described in the claims, and an embodiment which is obtained by appropriately combining technical means respectively disclosed in separate embodiments is also included in a technical range of the present invention. Furthermore, by combining technical means respectively disclosed in each embodiment, new technical characteristics can be formed.

### INDUSTRIAL APPLICABILITY

The present invention can be used for an image display apparatus which divides an image so as to display the image.

### REFERENCE SIGNS LIST

10, 10′ image signal processing device
11A, 11B input signal determination circuit (image signal determination unit)
12 synchronization circuit (synchronization unit)
100, 101 image display apparatus

1. An image signal processing device which outputs in parallel image signals that are assigned to respective division display areas obtained by dividing a display area of a display device into multiple pieces and that are synchronized with each other, comprising:
a synchronization unit which synchronizes the image signals that are assigned to the respective division display areas; and
an image signal determination unit which determines whether or not the image signal which is input to the synchronization unit is an image signal that can be synchronized by the synchronization unit,
wherein the image signal determination unit receives a first image signal group which includes a set of image signals that is assigned to the respective division display areas, and a second image signal group which includes another set of image signals that is assigned to the respective division display areas, and
wherein the image signal determination unit replaces an abnormal image signal which is determined not to be able to be synchronized by the synchronization unit, among the image signals which are included in either the first image signal group or the second image signal group, with an image signal which can be synchronized by the synchronization unit, according to an image signal which is included in either the first image signal group or the second image signal group.

2. The image signal processing device according to claim 1, wherein the image signal determination unit replaces the abnormal image signal which is included in either the first image signal group or the second image signal group, with an image signal which is included in either the first image signal group or the second image signal group.

3. The image signal processing device according to claim 2, wherein the image signal determination unit replaces the abnormal image signal which is included in one group of the first image signal group and the second image signal group, with an image signal which is assigned to the division display area corresponding to the abnormal image signal, among the image signals which are included in the other group of the first image signal group and the second image signal group.

4. The image signal processing device according to claim 1, wherein the image signal determination unit replaces the abnormal image signal with an image signal for displaying an analysis result of the abnormal image signal on the division display area.

5. The image signal processing device according to claim 1, wherein the image signal determination unit replaces the abnormal image signal with an image signal for displaying the whole surface of the division display area corresponding to the abnormal image signal, in a color according to the image signal group to which the abnormal image signal belongs.
